(19) United States
(12) Patent Application Publication
(10) Pub. No.: US 2006/0250221 A1
(43) Pub. Date: Nov. 9, 2006

(54) Strobe light system

(76) Inventors: Marc Henri, La Prairie (CA); Gilles Roy, La Prairie (CA)

Correspondence Address: Eric Fincham, 316 Knowlton Road, Lac Brome, QC, J0E 1V0, CA

(21) Appl. No.: 11/406,179

(22) Filed: Apr. 17, 2006

(30) Foreign Application Priority Data
Apr. 18, 2005 (CA) 2,503,165

(51) Int. Cl. H01S 3/30

(52) U.S. Cl. 340/286.11; 372/6

(57) ABSTRACT

A system for minimizing maintenance of tower mounted strobe light warning systems, the system comprising a first station located on the tower, the first station having a flash head and at least one capacitor mounted therein, and a second station mounted proximate a base of the tower, the second station including a switching power supply and a controller assembly. The above arrangement provides for a method of minimizing maintenance since most of the components are mounted proximate the tower base.

### FIELD OF THE INVENTION

The present invention relates a visual warning system and improvements thereto.

### BACKGROUND OF THE INVENTION

As is well known in the art, aeronautical communications frequently require the use of antenni which are mounted on top of a tower. Such towers can reach a substantial height—often extending up to 500 metres. These towers present a potential danger to aircraft in the area as they are not always readily visible, particularly under poor weather conditions. Accordingly, it is usually mandated by Governments that such a tower or any other structure shall be marked in accordance with certain standards.

A visual warning system is usually employed to warn pilots on a potential collision course with such a structure during the day or the night. Typically, flashing high intensity lights have been used with the intensity of the flash changing according to the ambient conditions. Thus, during daytime, a high intensity strobe light is usually employed while during night time, a much lower intensity light is utilized. A medium intensity may be used during the transition hours from light to dark and vice versa.

As is self-evident, such light emitting warning systems do require maintenance and due to the critical nature of the system, such repairs must be effected rapidly. This becomes a relatively expensive operation as the towers are frequently in remote locations and skilled people must be called in to climb the tower, diagnose the problem, and make repairs to the system.

A typical system will include a strobe light, one or more capacitors to store the charge for the flash, a transformer, and associated electronic components mounted on a circuit board. In order to effect the repairs, the technician must climb the tower, diagnose the problem, descend to the base to obtain the required components for repair, re-climb the tower, and install the new components.

Since there are different manufacturers of warning light systems, the people effecting the repair must carry a considerable number of replacement parts. This, in practice, means that a truck like vehicle must be employed.

As any owner of towers generally does not have enough towers in a single area to justify maintaining staff on hand for such repairs, it is frequently a third party contractor who makes the repairs. Again, distance to the location can become a problem.

One of the reasons for a relatively high rate of repair is the type of structure employed for the warning light assembly. As aforementioned, such assemblies typically contain the strobe lights, one or more capacitors, an electronic control system, etc. With each flash, ozone is created and as a result, corrosion of the various electronic components becomes a problem.

### SUMMARY OF THE INVENTION

It is an object of the present invention to provide improvements in warning light systems wherein the amount of maintenance on the system is reduced.

It is a further object of the present invention to provide an improved method for the installation of a visual light system on structures.

According to one aspect of the present invention, in a tower having a warning light system, the improvement comprising a light assembly mounted on the tower, the light assembly comprising a light emitting device and at least one capacitor for supplying electrical power to the light emitting device, and a control system mounted at the bottom of the tower, the control system comprising a switching power supply, and a control circuit, the control circuit being effective to control the intensity of the light emitting device and the frequency of flashing of the light emitting device.

According to a further aspect of the present invention, there is provided a method for minimizing maintenance of a tower mounted strobe light warning system, the method including the steps of placing a light head assembly on the tower, the light head assembly having at least one flash head and at least one capacitor mounted therein, and placing a second station proximate a base of the tower, the second station including a switching power supply and a controller circuit.

In greater detail, these warning light systems are normally placed at different levels of the tower or other structure. When used in a tower, typically three light heads are placed at any level with each light having a visibility of at least 120°. Depending upon the tower height, one can have up to seven different levels of lighting.

As stated above, the present invention utilizes three different modules. For mounting on the tower, there is provided the light assembly which will include the light emitting device as well as one or more capacitors associated therewith. This is the only portion mounted on the tower and accordingly, the maintenance thereof is minimal since the capacitors have a long life as does the lighting device which is typically a xenon tube. A xenon tube will normally function for at least seven years before requiring replacement.

Mounted at the base of the unit is an assembly which will include the power switching supply as in one module and a controller module. Each controller module will preferably be adapted to control all the power supply units at any one level. A single controller can be utilized to control between three to ten light assemblies.

The controller has a primary function of controlling the synchronization of the different lighting heads and to control the intensity of the lighting heads as well as coordinating the entire system.

Preferably, the intensity is determined by two photoelectric cells each of which has a predefined level such that one is suitable for night and the other for the transition hours between daylight and dark. Naturally, the intensity is at its maximum during the day and at a minimum at night. The intensity level is well defined in the standards of the FAA.

Communication between the controller and the power supply units is established by an RS-485 network. A master/slave protocol is utilized. In normal operation, the controller is the master. If a problem arises in one of the power units or if the controller is defective, communication between the power units is still possible.

If a problem is detected by the controller, several actions can be taken. First of all, the malfunction is registered and then signalled by means of LED's or like devices. Depending upon the nature of the problem, one of the two alarm relays can also be activated. These alarms can be connected to suitable communication means (modem, cellular, etc.).

The controller module will preferably have display means which enable one to quickly glance thereat to determine the functioning of the system. There may also be provided means such as push buttons which can be utilized to configure the different parameters.

The power unit is designed to feed power to the light head and to control the flashing. Again, suitable display means may be provided to indicate the status thereof.

The light assembly will include a suitable light emitting device and to this end, typically xenon tubes are lighted by the discharge of a capacitor. The flashing frequency may vary and is typically between one and five seconds.

In a preferred embodiment, the controller and power supply are each manufactured as a module which is preferably of a plug-in type. In so doing, rather than attempting repairs on site, a module which is defective is removed and replaced by the technician. The defective modules can then be forwarded to a repair centre for repair.

### BRIEF DESCRIPTION OF THE DRAWINGS

Having thus generally described the invention, reference will be made to the accompanying drawings illustrating embodiments thereof, in which:

FIG. 1 is a schematic diagram illustrating the overall arrangement of a visual warning system;

FIG. 2 is a view of the interface with the controller;

FIG. 3 is an illustration of the interface for the power unit;

FIG. 4 is a schematic of the light head assembly;

FIG. 5 is a schematic of a typical system;

FIG. 6 is a schematic of a modular system for controlling a series of lights on different levels;

FIG. 7 is a schematic of the controller; and

FIG. 8 is a schematic of the power unit.

### DETAILED DESCRIPTION OF THE INVENTION

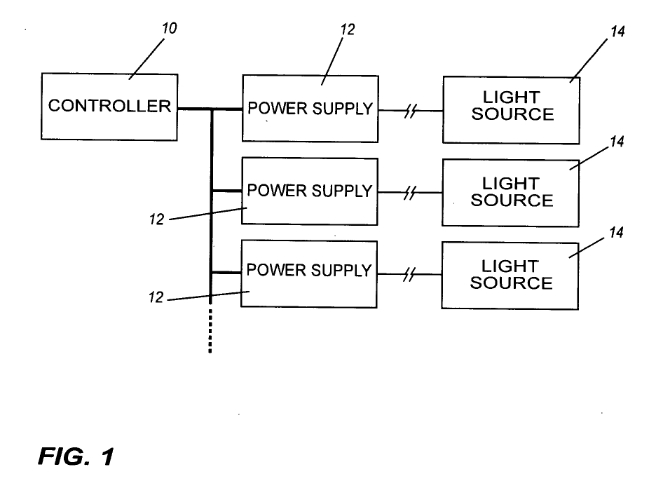

Referring to the drawings in greater detail and by reference characters thereto, FIG. 1 illustrates a base system wherein a controller 10 and power supplies 12 are placed on the ground near the base of the tower while situated remotely therefrom are the light head assemblies 14.

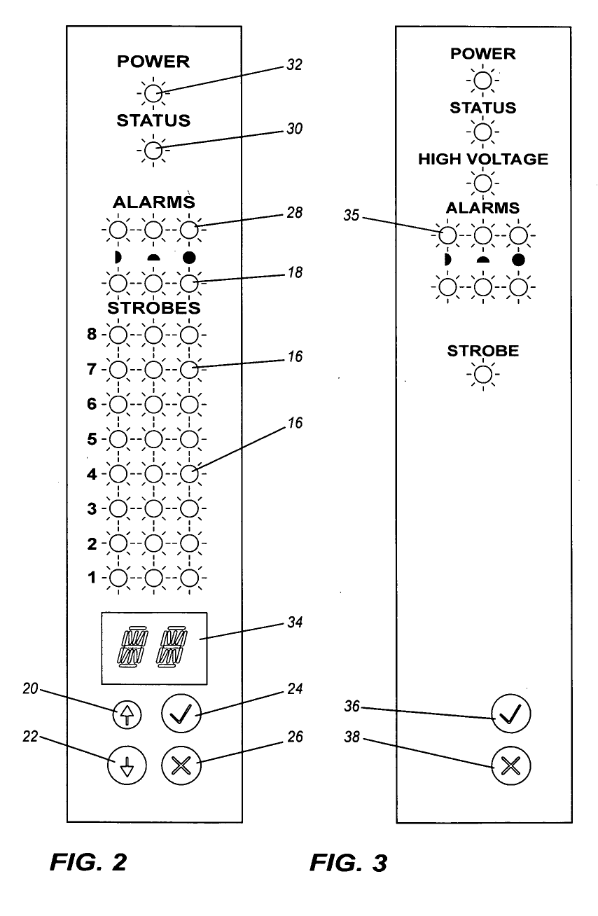

FIG. 2 illustrates the interface with the controller. The controller has as a principal task the function of assuring the synchronization of the different light head assemblies 14 and of controlling the intensity of the light and supervising the whole of the system.

The intensity of the light is determined by two photoelectric cells which are mounted exteriorly. The photo cells are operative to control the lighting, one of the cells being for dusk and the other for night time. In full daylight, the intensity is at its maximum while at night, the lighting is generally at a minimum. At dusk, an intermediate setting is utilized.

The communication link between the controller and the power units is done using an RS-485 network. The protocol is that of a master/slave which in normal times, the controller is master. However, if a problem occurs in one of the power units or if the controller is defective, the communication can continue between the power units.

If a problem is detected by the controller, several actions are taken. Firstly, the problem is registered and a light is used to signal the problem. If necessary, one of the two alarm relays could be activated to send a report. This can be done by modem, cellular, etc.

The interface of the controller with the user is accomplished by use of LED's. The settings of the controller can be modified through use of buttons 20, 22, 24 and 26. Thus, buttons 20 and 22 which are arrow keys can be utilized to program the system to the desired parameter at which time the button 24 would be pressed to enter the setting or button 26 to cancel. Some of the parameters which can be programmed would be the flash rate, the number of levels, the number of flash heads, the time and the date, the light intensity and switching between automatic and manual mode. Thus, as shown in FIG. 2, a plurality of LED's 16 may be utilized to indicate the proper functioning of the strobes at the various levels. The LED's 18 will indicate the flash intensity (daylight, night time or dusk). The LED's 28 may be used to visual alarms while LED's 30 and 32 indicate the status and power on or off respectively. A display 34 may be provided in a conventional manner.

FIG. 3 illustrates the interface for the power unit. The different lights indicate the status of the unit and of the light head assembly it controls. As will be noted, there can be a high voltage alarm 35 which indicates that there is excessive voltage present in the interior of the unit or the interior of the light head assembly. Keys or buttons 36 and 38 may be provided as was the case for the controller unit.

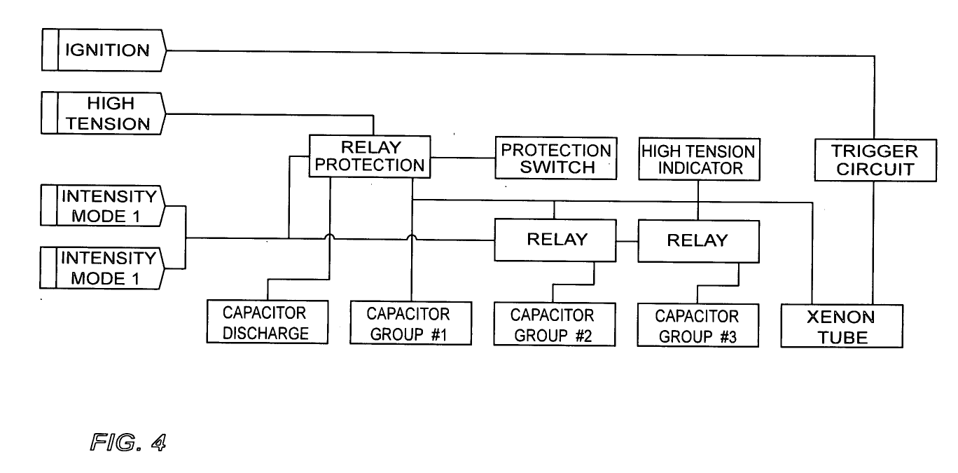

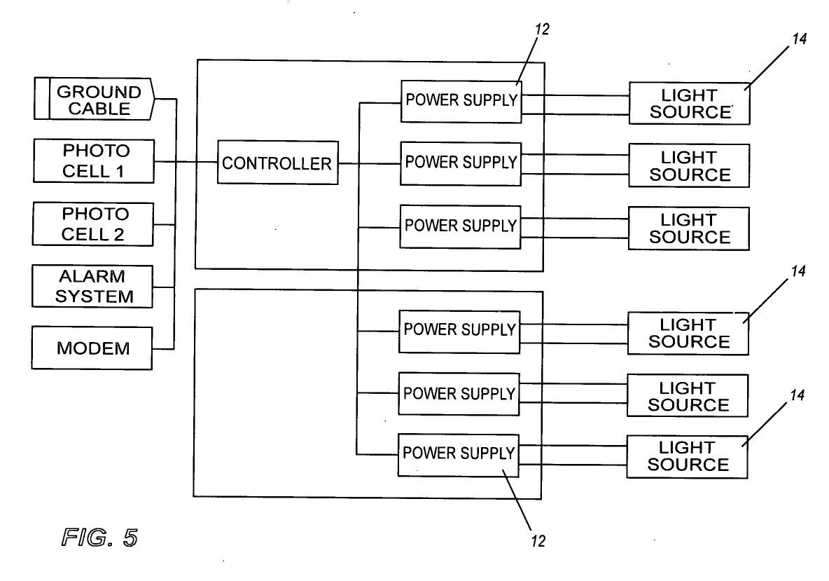

FIG. 4 is a schematic of the light head assembly. Inside the light head assembly are the capacitors which control the intensity of the light. Thus, each capacitor or bank of capacitors is arranged to control a given light level as previously described. As may be seen, the light head assembly carries a minimum number of components and thus maintenance involving climbing the tower is minimized.

The power supply unit is preferably manufactured as a module and operates on a plug-in basis. Thus, should any component become defective, the technician merely needs to remove the entire module and plug in a replacement module. The defective module can then be sent to a repair center.

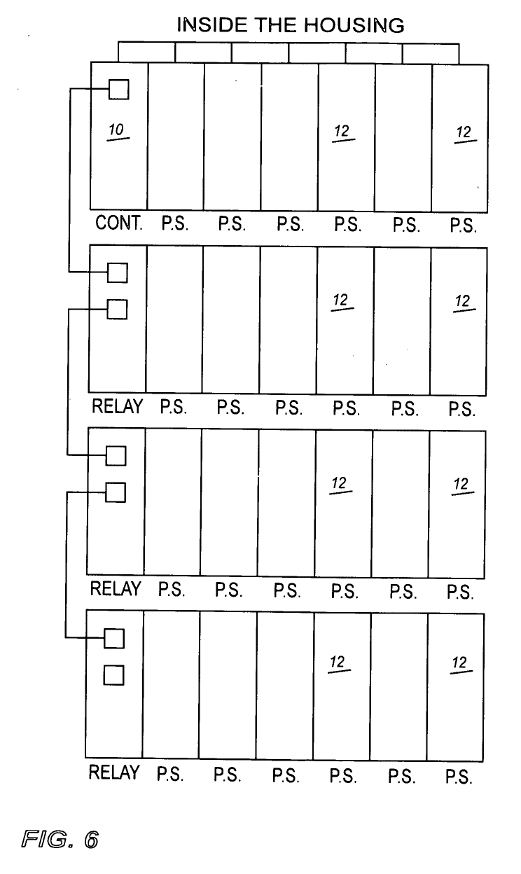

FIG. 6 illustrates an arrangement wherein the modular power supply units 12 may be placed inside a rack which can contain six of the power supply units 12. As may be seen, there is provided a relay extending from one row of power supplies 12 to other rows.

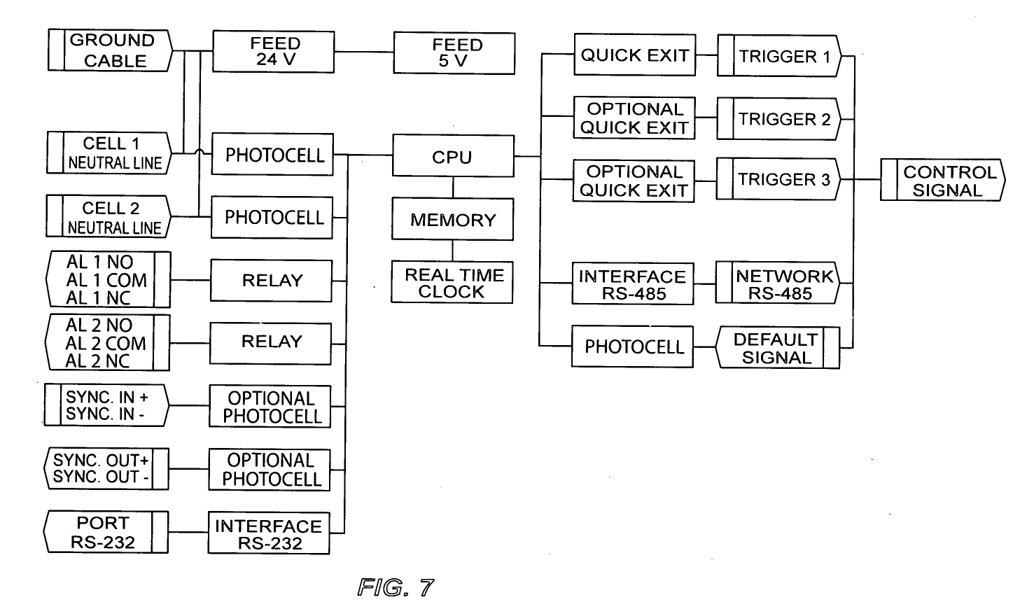

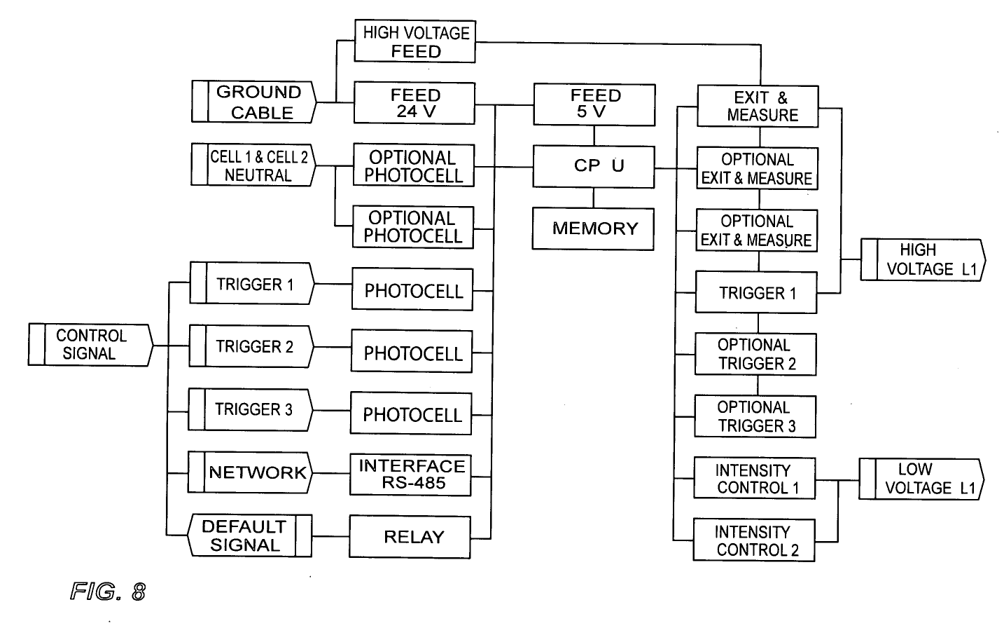

FIG. 7 is a schematic of the controller and as may be noted, there are provided a pair of photocells. In the illustrated embodiment, there are provided three lighting levels.

In FIG. 8, there is illustrated a schematic for the power supply units. The two high tension outlets and photocells are an optional arrangement and can be included to provide redundance in the system.

It will be understood that the above described embodiments are for purposes of illustration only and that changes and modifications may be made thereto without departing from the spirit and scope of the invention.

We claim:

1. In a tower having a warning system thereon, the improvement comprising:
a first station located on said tower, said first station having a flash head and at least one capacitor mounted therein; and
a second station mounted proximate a base of said tower, said second station including a switching power supply and a controller assembly.

2. The improvement of claim 1 further including a plurality of first stations mounted on said tower, each of said plurality of first stations having a respective switching power supply in said second station.

3. The improvement of claim 1 further including means for controlling the light intensity of a light mounted in said flash head.

4. The improvement of claim 1 wherein said controller assembly includes means for providing for three different light intensities, said light intensities being determined by photocell means.

5. The improvement of claim 4 further including capacitors mounted in said first station, each of said light intensities being dependent on at least one separate capacitor.

6. The improvement of claim 1 wherein said tower has a plurality of first stations arranged at different levels of said tower.

7. The improvement of claim 6 wherein each level has at least three first stations.

8. The improvement of claim 2 wherein said flash head includes a xenon tube as a light source.

9. The improvement of claim 1 wherein said second station includes a rack, each rack having a plurality of modules plugged therein, each module being a switching power supply.

10. A method for minimizing maintenance of a tower mounted strobe light warning system, the method including the steps of placing a light head assembly on said tower, said light head assembly having at least one flash head and at least one capacitor mounted therein; and
placing a second station proximate a base of the tower, said second station including a switching power supply and a controller circuit.
